(19) United States
(12) Patent Application Publication
(10) Pub. No.: US 2009/0128272 A1
(43) Pub. Date: May 21, 2009

(54) HALBACH MAGNET ARRAY FOR NMR INVESTIGATIONS

(75) Inventor: Brian Philip Hills, Norwich (GB)

Correspondence Address: FISH & RICHARDSON P.C., PO BOX 1022, MINNEAPOLIS, MN, 55440-1022, US

(73) Assignee: PLANT BIOSCIENCE LIMITED, Norwich (GB)

(21) Appl. No.: 11/913,630

(22) PCT Filed: Apr. 28, 2006
(86) PCT No.: PCT/GB06/01548

§ 371 Date: Aug. 1, 2008

(30) Foreign Application Priority Data
May 5, 2005 (GB) 0509144.2

(51) Int. Cl. H01F 7/02

(52) U.S. Cl. 335/306

(57) ABSTRACT

A magnet array for use with NMR signal acquisition apparatus uses rod-shaped magnets located at the corners of a square. The square lies in the (x-y) plane of a three dimensional Cartesian coordinate system and the long axes of the magnets extend generally along the z-direction such that the polarisation vectors of the magnets lie substantially in the x-y plane. The magnets are arranged to create a substantially uniform magnetic field B₀ in a sample volume at the centre of the polygon. The widths of the magnets are less than the length of the sides of the square so that there is a gap between magnets allowing lateral access in the x-y plane to the sample volume. Each magnet may be rotatable about its longitudinal axis to change one and/or both the B₀ field direction and magnitude in the sample volume. At least one magnet may be displaceable in a direction orthogonal to its longitudinal axis to change one and/or both the B₀ field direction and magnitude in the sample volume.

The present invention relates to magnet arrays suitable for use in nuclear magnetic resonance (NMR) signal acquisition and magnetic resonance imaging (MRI), and in particular though not exclusively to magnetic field apparatus which admits of access in real-time to a sample contained within the magnetic field apparatus during NMR analysis, including access for analysis by at least one analytical method in addition to and in conjunction with the NMR analysis.

It is generally understood that no single spectroscopic or imaging technique is able to provide a complete characterisation or analysis of the hugely diverse range of natural and synthetic complex materials ranging from foods to plastics. Combinations of different techniques are usually required to research a new or unknown material. The list of available techniques is very long and includes analysis based on, e.g. near infra-red reflectance (NIR), Fourier transform infra-red (FTIR), optical, fluorescence, ultrasonic and impedance spectroscopy, x-ray diffraction and so on. Combining spectroscopic and imaging data from other techniques with NMR would greatly increase the power of the combined approach and would have important applications in many other fields, including clinical diagnosis, food science, agriculture, biotechnology and materials science.

Unfortunately, one of the most powerful techniques, namely NMR and its imaging mode MRI, encloses the sample in arrays of magnets and coils malting it extremely difficult, if not impossible, to combine the technique with simultaneous measurements using any other spectroscopic or imaging technology. Instead, samples must be physically removed from the NMR apparatus before they can be examined with other techniques. This is time consuming and, in cases where samples undergo irreversible physical or chemical changes in real time, highly undesirable.

In many cases it would be desirable to be able to physically manipulate the sample while it is undergoing NMR. For example, in materials science it would be desirable to be able to stretch, compress, rotate or shear the sample while it is being examined in real time with NMR. i.e. have ‘open-access’ to the sample while it is undergoing NMR analysis.

Open-access NMR/MRI is not possible with present day commercial instruments where the sample is enclosed in arrays of magnets, shim and RF coils. NMR spectrometers based on superconducting magnets surround the sample with a closed superconducting magnet containing jackets of liquid helium and nitrogen together with complex arrays of shim and gradient coils. Access is further restricted by the need to surround the sample with an RF coil, such as a saddle, birdcage or solenoid RF coil. The same is true of resistive electromagnets, though this type of magnet is rarely used today. Lower cost commercially available bench-top NMR spectrometers based on permanent magnets usually place the sample between the poles of two parallel magnet blocks and enclose the sample with a solenoid RF coil. Here again access to the sample is highly restricted.

Open-access to the sample is presently afforded by existing one-sided magnet systems such as the NMR MOUSE (‘mobile universal surface explorer’) which allows measurement of NMR relaxation and diffusion parameters in near-surface volume elements of arbitrarily large objects. However, because of their one-sided symmetry, field homogeneity is greatly reduced in one-sided NMR systems. Consequentially, the NMR has to be performed in a strong field gradient. For example the NMR Mouse operates in a field gradient of the order of 10 T/m so that the NMR signal (proportional to the transverse magnetisation) is strongly attenuated by the diffusion of small molecules through the field gradient. The combination of field inhomogeneity and slice selective RF means that only signal from the sample surface to a depth of a few mm is possible with the Mouse unless magnetic field sweep techniques are used to extend the depth profiling to a maximum of 10 mm. Well-logging NMR systems also use one-sided magnet arrangements and similarly receive signal from a relatively small volume in a strong field gradient.

In US2002/0179830, there is disclosed a Halbach dipole magnet shim system and method for shimming a full Halbach array. A full Halbach array utilizes N magnets in the N corners of an N-sided polygon, defining a closed cylinder of the N magnets (i.e. there is not open access). US '830 refers to shimming the field in this closed cylindrical array.

Halbach dipole magnets, originally proposed by Klaus Halbach as focusing magnets for particle accelerators [1], are permanent magnets consisting of segments joined together in such a way as to create a dipole magnet with the dipole transverse to the long axis of the magnet. A number of Halbach dipoles can be combined in an array so as to create a homogeneous magnetic field transverse to the long axis of the array, an arrangement which is convenient for NMR because a solenoid can more easily be used for the NMR RF coil rather than a saddle coil. Halbach arrays have previously been used in a number of NMR applications (see for example [2]-[6]). Typically in NMR one wants to homogenize the field by combining as many Halbach dipoles as possible in a polygonal or circular array. This closes off the sample from access in the lateral direction (i.e. in the plane of magnetization).

It is an object of the present invention to provide a magnet array for use with NMR signal acquisition apparatus that allows easy access to a sample located within a sample volume within the magnet array.

It is a further object of the present invention to provide a magnet array for use with NMR signal acquisition apparatus that allows the magnetic field direction and magnitude in a sample volume to be altered under the control of a robotic system operable to impart physical movement to one or more of the magnets in the array.

The present invention takes advantage of alternative advantages of reducing the number of dipoles in a Halbach array to a bare minimum, sacrificing some homogeneity in favour of a more open magnet design.

A rectangular Halbach magnet array may be constructed with four dipole magnets sufficiently far apart, relative to the NMR-sensitive region close to the field centre, that the arrangement may legitimately be described as open-access (or easy-access). By this, we mean that there is an open space surrounding the RF coil which is larger (relative to the magnet gap) than in conventional magnet/probe designs. This allows for larger samples or the introduction of other equipment for manipulating or observing the sample. There may be some disadvantages of such a design such as reduced and relatively inhomogeneous B₀ field, although the confinement of flux in a properly-symmetrised Halbach configuration does help to optimize the homogeneity as much as possible under the circumstances, and spin echo experiments can be used. There may also be reduced sensitivity and signal/noise ratio.

These disadvantages are offset, for certain applications, by at least three advantages. First is the relative ease of construction and low cost of the magnet array. Second is the portability of the magnet, which does not require a heavy steel yoke to carry the flux lines. Third, and most significant, is the open-access nature of the Halbach array which allows for several lines of further development.

Open access allows for the use of multi-sensor technologies and techniques, e.g. combining NMR/MRI with, e.g.: other spectroscopies such as EPR (electron paramagnetic resonance), NIR, microwave reflectance etc; scattering techniques using x-rays, neutrons, lasers etc, ultrasonics, and/or electrochemical measurements including impedance spectroscopy, voltammetry etc. Multi-spectral domains can be scanned independently or combined by means of multi-dimensional correlation spectroscopy techniques [7]. The inventor's experiments with a Halbach array have succeeded in combining NMR with impedance spectroscopy on a gel sample.

Easy access to samples in the NMR apparatus also allows for mechanical micro-manipulation of samples during NMR or other spectroscopic investigation, facilitating a variety of NMR-rheology experiments.

There is more available space (relative to a conventional NMR design) to introduce the means to subject the sample to extremes of temperature and/or pressure. Samples can be physically moved through the magnet space by pipes, conveyors and the like.

In principle the size of the array can be scaled up or down. A sufficiently large array can allow NMR or even low-resolution MRI of large intact samples such as foodstuffs, human limbs and the like.

It is interesting to compare the open-access Halbach array with other magnet/probe designs which may be regarded as being of open-access type. These include surface coils and the NMR-MOUSE ([8], [9]) which is simply applied to the exterior of the subject under study, and there is no enclosing magnet. Using a locally-applied magnetic field, one-sided NMR systems suffer from poor field homogeneity. Application of such designs is typically limited to relaxation measurements, lineshape analysis and MRI. Signal is only obtained from a thin surface layer (a few mm) of the subject. It is thus very difficult to do simultaneous spectroscopy at other wavelengths, scattering experiments, rheology and the like on the same region of the sample which is undergoing NMR excitation. The open-access Halbach array may be regarded as being, in a sense intermediate between the NMR-MOUSE and its cousins, and more conventional designs. The subject is enclosed inside the magnet array in a moderately homogeneous field, but is not tightly confined between the pole pieces. The flat solenoid RF coil employed in the current design resembles a surface coil in that large samples can be placed on or near it to get a signal, but better B₀ homogeneity should allow excitation of a larger sample volume.

The present disclosure describes the successful design and testing of a simple open-access Halbach magnet array and RF coil system capable of low-field, low-resolution NMR.

According to one aspect, the present invention provides a magnet array for use with NMR signal acquisition apparatus, comprising:
N rod-shaped magnets of length L and width D, where L>D, each magnet being located at a respective corner of a polyhedron having N sides and N corners where N is an integer greater than 2,
wherein the polyhedron lies in the (x-y) plane of a three dimensional Cartesian coordinate system with the long axes of the magnets extending generally along the z-direction such that the polarisation vectors of the N magnets lie substantially in the x-y plane and are arranged relative to one another so as to be capable of creating a substantially uniform magnetic field B₀ in a sample volume at the centre of the polyhedron,
wherein the width D of at least one magnet is less than the length of the corresponding side of the polyhedron so that there is a gap between at least two neighbouring magnet rods thereby providing lateral access in the x-y plane to the sample volume.

According to another aspect, the present invention provides a magnet array for use with NMR signal acquisition apparatus, comprising:
N rod-shaped magnets of length L and width D, where L>D, each magnet being located at a respective corner of a polyhedron having N sides and N corners where N is an integer greater than 2,
wherein the polyhedron lies in the (x-y) plane of a three dimensional Cartesian coordinate system with the long axes of the magnets extending generally along the z-direction such that the polarisation vectors of the N magnets lie substantially in the x-y plane and are arranged relative to one another so as to be capable of creating a substantially uniform magnetic field B₀ in a sample volume at the centre of the polyhedron,
wherein some or each of the magnets are rotatable about their respective longitudinal axes under the control of a robotic system to change one and/or both the B₀ field direction and magnitude in the sample volume.

According to another aspect, the present invention provides a magnet array for use with NMR signal acquisition apparatus, comprising:
N rod-shaped magnets of length L and width D, where L>D, each magnet being located at a respective corner of a polyhedron having N sides and N corners where N is an integer greater than 2,
wherein the polyhedron lies in the (x-y) plane of a three dimensional Cartesian coordinate system with the long axes of the magnets extending generally along the z-direction such that the polarisation vectors of the N magnets lie substantially in the x-y plane and are arranged relative to one another so as to be capable of creating a substantially uniform magnetic field B₀ in a sample volume at the centre of the polyhedron,
wherein at least one magnet is displaceable in a direction orthogonal to its longitudinal axis under the control of a robotic system to change one and/or both the B₀ field direction and magnitude in the sample volume.

The new Halbach NMR spectrometer of the present invention differs from all heretofore known systems because the sample is easily accessible from the outside, while at the same time, the NMR signal is received not from just the surface regions but from inside the body of the sample. Such an arrangement is easily combined with other spectroscopies and allows sample manipulation.

Accordingly, objects of the present invention include the provision of a Halbach NMR spectrometer amenable to:

a) Simultaneous examination of the analyte with other technologies based on electromagnetic radiation of any desired frequency. Examples include impedance spectroscopy, intra-red, NIR, optical or tuneable lasers, ultraviolet, x-rays, gamma rays, etc. Three-dimensional surface scanning with 3D laser technology is possible as is taking optical images with CCD arrays.

b) Simultaneous irradiation of the analyte with particle beams, gamma rays or any other form of beam.

c) Real-time physical movement of the analyte inside the spectrometer. Thus different parts of the sample can be examined, permitting a simple form of imaging.

d) Real-time modification of the analyte inside the spectrometer. Thus, the analyte examined in the apparatus of this invention could be cut, dissected, stretched, sheared, rotated etc while being examined with NMR/MRI.

e) Application of a hand-held probe which can, therefore, be taken to the sample rather than the sample taken to the spectrometer.

f) Examination of analytes without the need for the analyte to be cut or sliced to fit into conventional NMR tubes or sample holders. Sub-regions of whole samples are therefore subject to be examined non-invasively. The only limitation of sample size is the requirement that it can fit between adjacent Halbach magnets.

Other objects and advantages of the invention will be appreciated from a review of the full disclosure and the appended claims.

Embodiments of the present invention will now be described by way of example and with reference to the accompanying drawings in which:

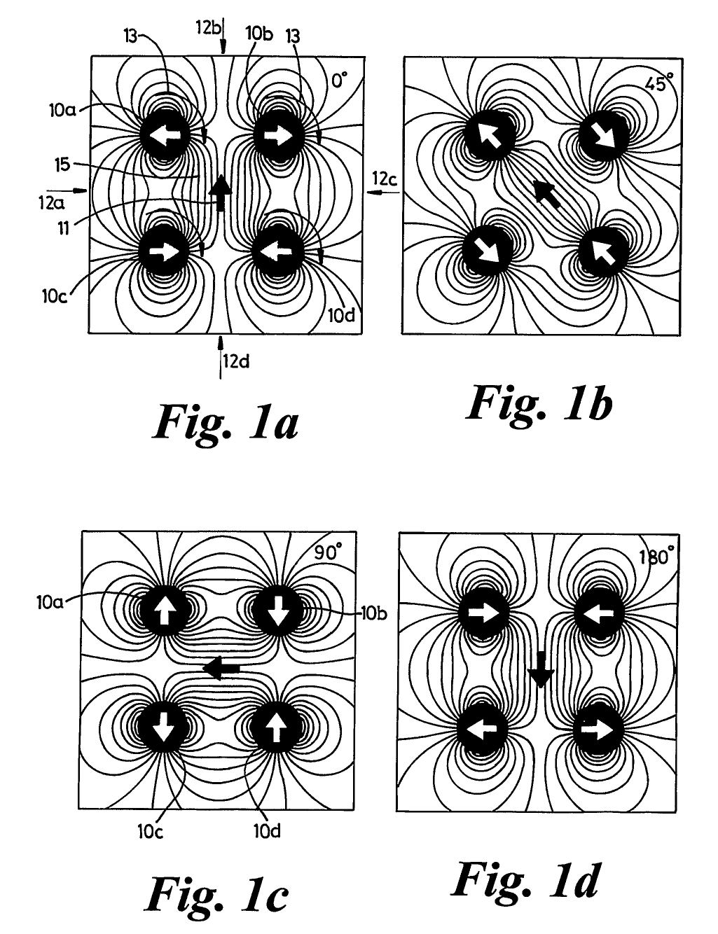

FIGS. 1a to 1d are schematic diagrams showing magnet field lines for a square arrangement of four rod-like magnets. The filled circles represent end cross-sections of magnetised rods and the arrows therein indicate the direction of magnetisation inside the rods. The central arrows show the direction and magnitude of the magnetic field B₀. The lines indicate the magnetic field contours. The curved arrows indicate a direction of rotation of the magnetised rods.

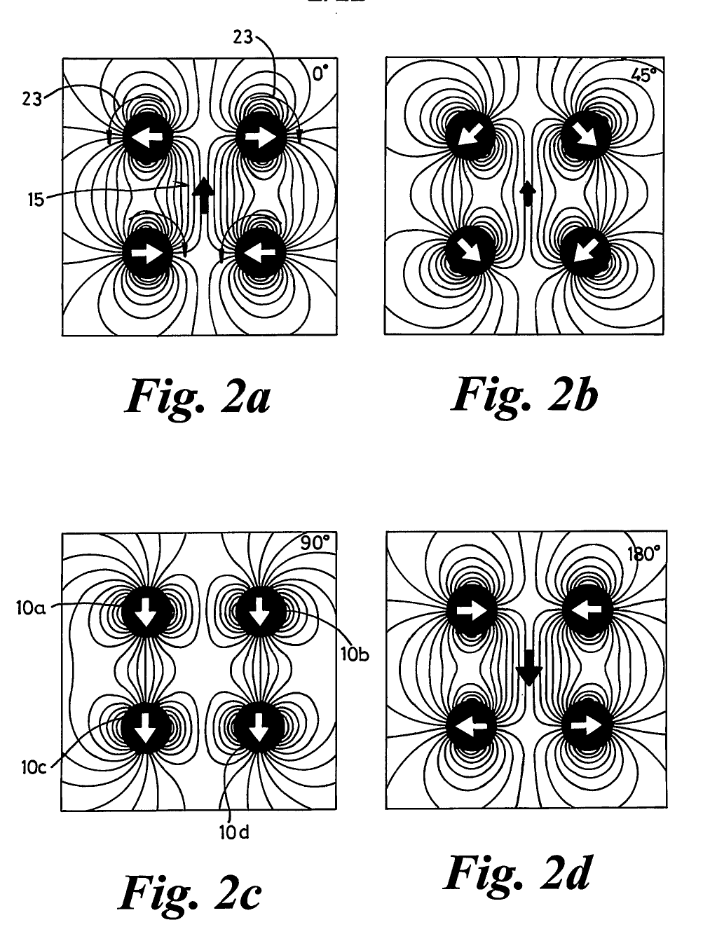

FIGS. 2a to 2d are schematic diagrams showing magnet field lines for a square arrangement of four rod-like magnets, similar to FIGS. 1a to 1d but with a different rotation strategy indicated by the curved arrows.

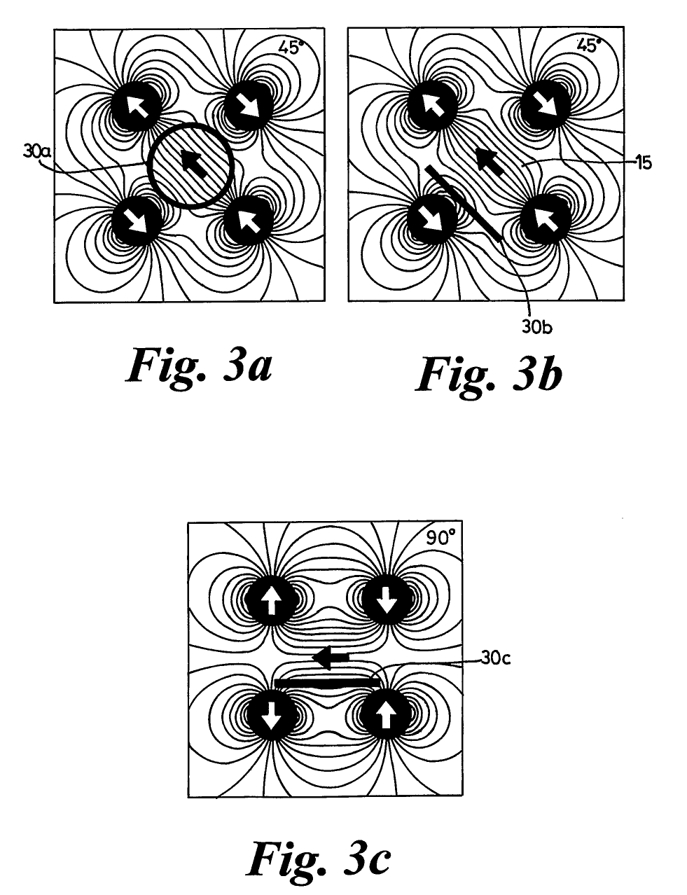

FIGS. 3a to 3c are schematic diagrams similar to FIG. 1 showing three possible configurations for a square Halbach array with four magnets and a single RF coil giving a B₁ field perpendicular to the B₀ field from the four rod-like magnets.

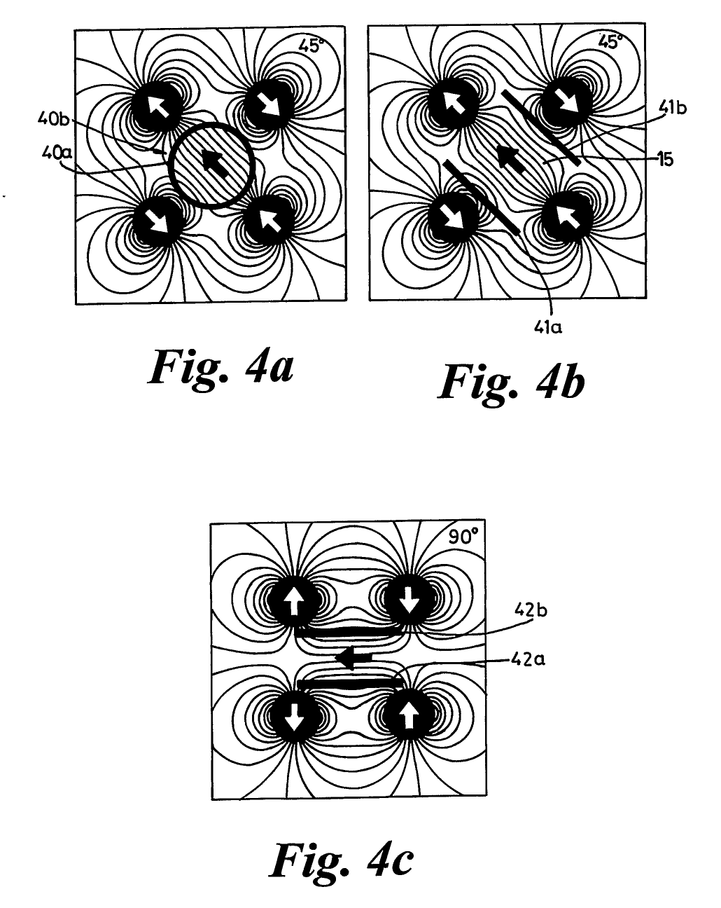

FIGS. 4a to 4c are schematic diagrams similar to FIG. 1 showing three possible configurations for a square Halbach array with four magnets and two RF coils arranged as a Helmholtz pair giving a B₁ field perpendicular to the B₀ field from the four rod-like magnets.

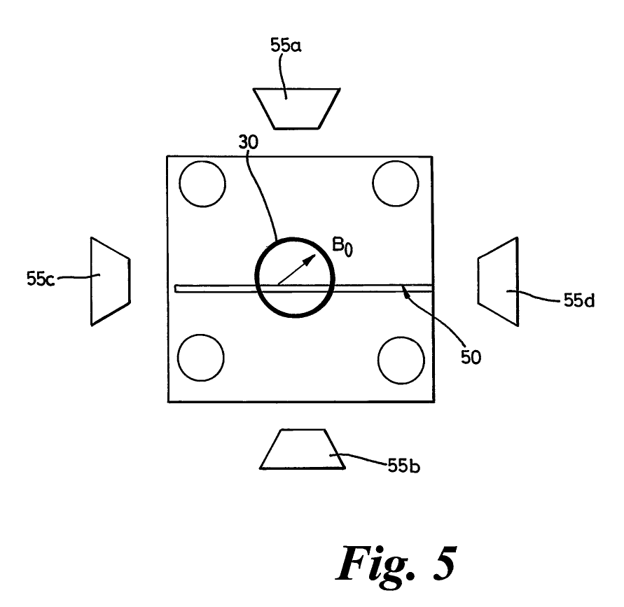

FIG. 5 is a schematic end-view of a Halbach NMR spectrometer showing possible locations for and dispositions of non-NMR sensors and an RF coil.

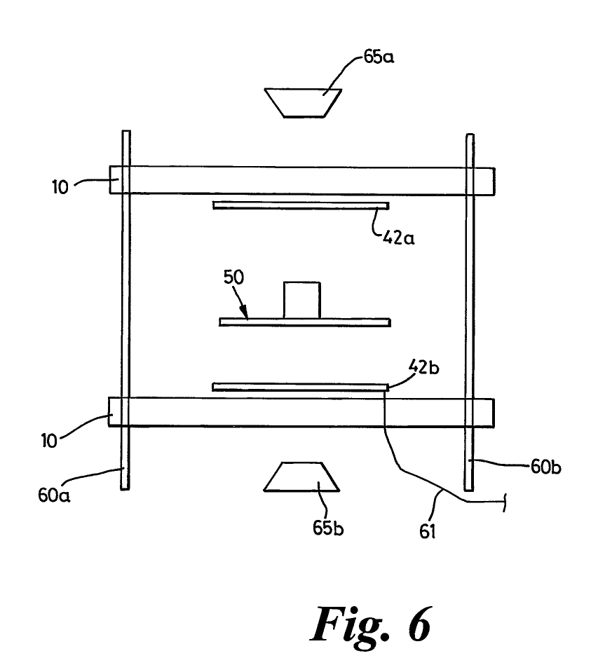

FIG. 6 is a schematic side view of a Halbach NMR spectrometer showing possible locations for and dispositions of non-NMR sensors and a pair of RF coils.

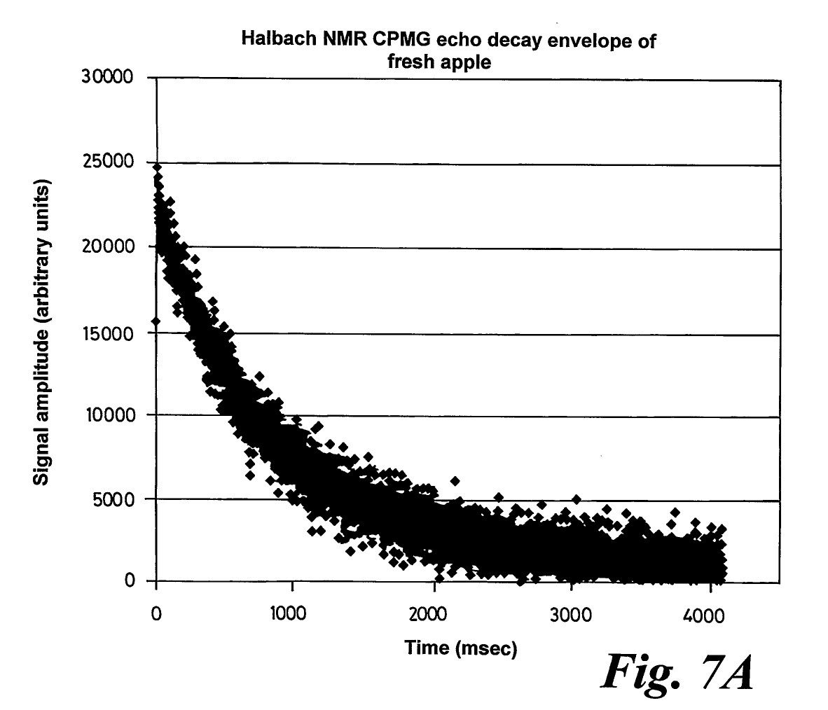

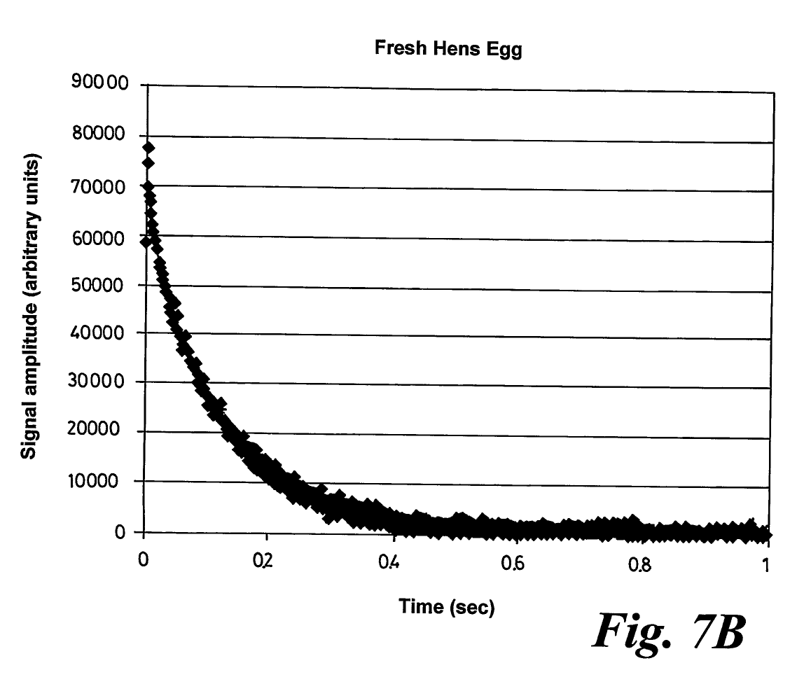

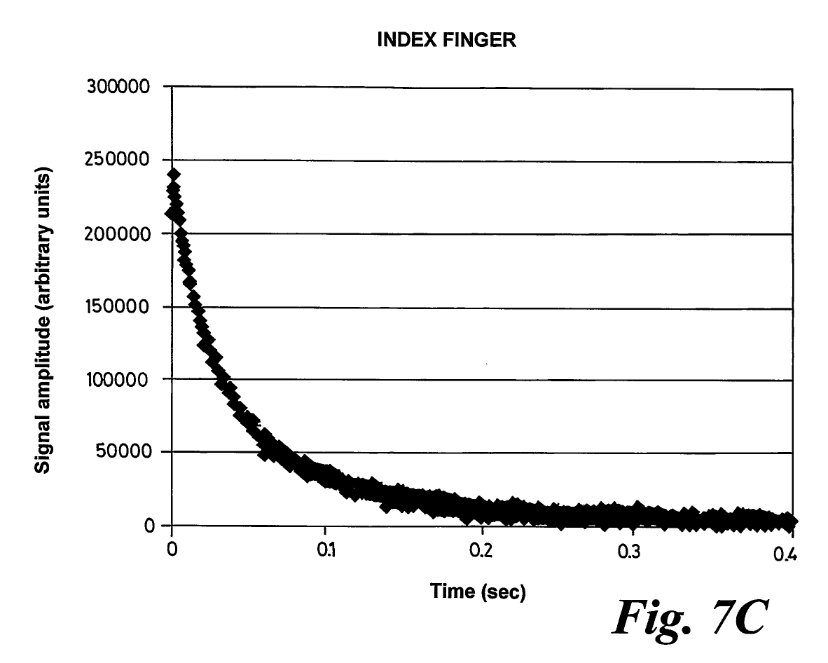

FIG. 7A shows a CPMG echo decay envelope of a whole apple placed in the Halbach NMR spectrometer of FIG. 5.

FIG. 7B shows a CPMG echo decay envelope of fresh hen's egg in the Halbach NMR spectrometer of FIG. 5.

FIG. 7C shows a CPMG echo decay envelope of an index finger using the Halbach NMR spectrometer of FIG. 5.

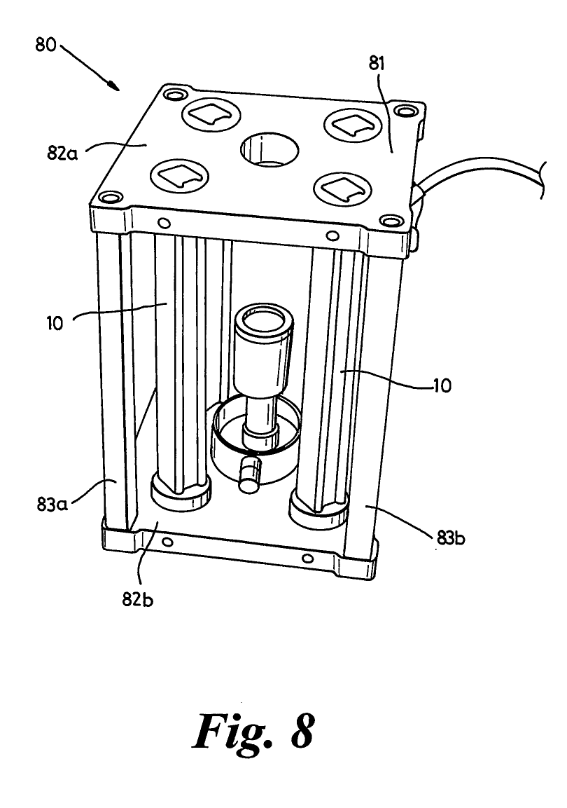

FIG. 8 is a perspective view of a Halbach NMR spectrometer based on a single RF coil. The B₀ field is created with four transverse polarised square rods of neodymium-ferrite. An aluminium frame is used to hold the magnets. A flexible coaxial cable connects to a tuning box. An adjustable support for the RF coil is used. The position of the coil can be mechanically adjusted to locate the field centre.

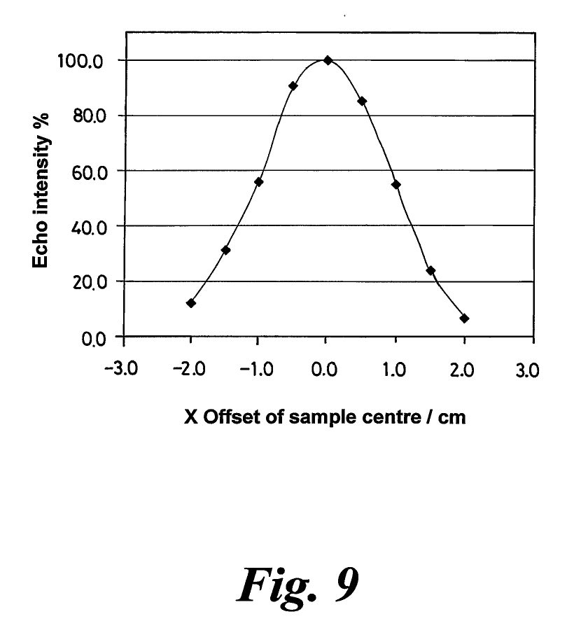

FIG. 9 is a graph showing relative sensitivity of the RF coil of FIG. 8 as a function of position along the coil axis.

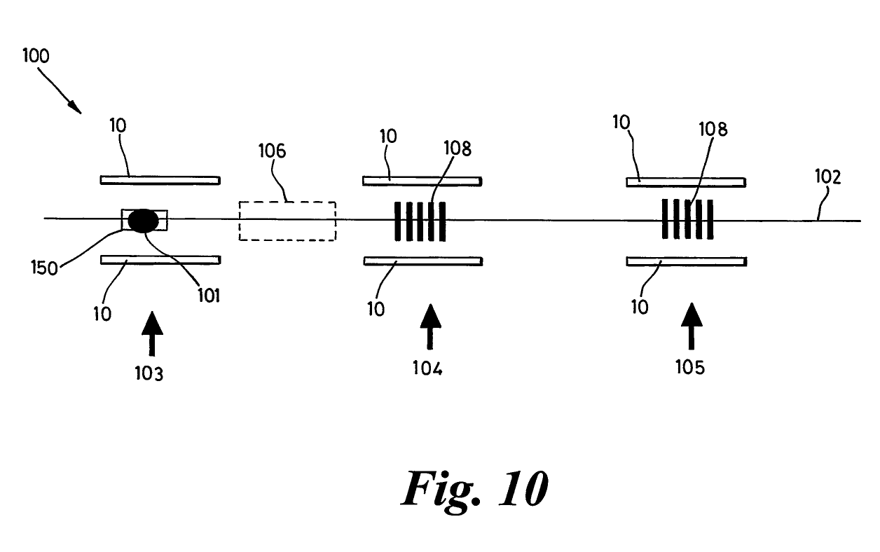

FIG. 10 is a schematic diagram of a multiple magnet array for translational NMR.

A preferred NMR apparatus according to the present invention uses a set of N transverse polarised permanent magnet rods aligned parallel at the apexes of a polyhedron. With reference to FIG. 1, a preferred arrangement arises when N is 4 and the magnet rods 10a, 10b, 10c, 10d are arranged at the corners of a square, having their longitudinal axes orthogonal to the plane of the drawing. The rod-shaped magnets have a length L and a width or diameter D, where L>D, each magnet being located at a respective corner of the polyhedron. The polyhedron lies in the (x-y) plane of a three dimensional Cartesian coordinate system with the long axes of the magnets extending generally along the z-direction such that the polarisation vectors of the magnets lie substantially in the x-y plane. The width D of the magnets is less than the length of the corresponding side of the polyhedron so that there is a gap between at least two neighbouring magnet rods. Preferably the magnets are exactly parallel although non-parallel magnet configurations may be used as discussed later.

This arrangement creates a transverse magnetic field 11 in the centre of the square allowing open-access to a sample, contained within a sample volume 15, in four directions 12a, 12b, 12c, 12d between the magnet rods 10. Rotating the magnets 10 about their individual longitudinal axes allows the direction and magnitude of the transverse magnetic field at the centre of the square to be varied continuously, as explained later. The magnets 10 preferably consist of a highly polarised material, including but not limited to neodymium-ferrite rods, which are light weight and low cost. Other exemplary materials include magnetically polarised sintered ferrite and sintered samarium cobalt.

FIGS. 1 and 2 show that a uniform magnetic B₀ field 11 is created in the sample volume 15 in the central part of the polygon. This field 11 is utilized to create an NMR signal from samples placed between the magnets 10. The magnetised rods are held in place by rigid non-magnetic end-plates 60a, 60b (see FIG. 6) containing holes arranged in the corners of the polygon as described later.

As mentioned above, the preferred embodiments of FIGS. 1 and 2 deploy magnet rods 10a . . . 10d that are exactly parallel and which have uniform strength along their length, i.e. the transverse magnetic field is invariant as a function of z-position. In other embodiments, it may be useful to vary the strength of the transverse field as a function of z. This can be achieved, for example, by having somewhat non-parallel magnet rods 10 whose longitudinal axes converge or diverge from one another as a function of z. Alternatively, the magnet rods themselves may have a transverse field strength that varies as a function of z, e.g. by using tapered magnets whose width or diameter D varies as a function of z.

Returning to the configurations shown in FIGS. 1 and 2, in the simplest arrangement, a radiofrequency field, B₁, perpendicular to B₀, is created by a simple coil of copper wire 30a, 30b, 30c located in one of the three configurations, as shown in FIG. 3. The only requirement is that the main magnetic field, B₀, is perpendicular or transverse to the magnetic field component, B₁, of the RF field generated by AC current through the coil 30. Alternative arrangements, shown in FIGS. 4a, 4b and 4c, use a pair of coils 40a, 41a, 41b, 42a 42b (called a Helmholtz pair) arranged as shown. Note that, in FIG. 4a, the second coil 40b is located directly behind first coil 40a and is therefore not visible.

The RF coils 30, 40, 41, 42 are connected by flexible coaxial cable 61 (see FIG. 6) to standard NMR equipment known in the art (not shown) for transmitting RF pulses and receiving and amplifying NMR signals. Such NMR equipment typically comprises power sources, a RF frequency synthesiser and amplifier, a preamplifier and filter as well as a computer for data display and manipulation.

NMR is possible from the sample volume 15 comprising a small region in the centre of the square array. No useful NMR signal is expected from outside the region, because the B₀ and B₁ field inhomogeneity would destroy the resonance condition and cause rapid dephasing of transverse magnetisation in a time short compared to the ringdown time of the receiver/transmitter RF coil(s) 30, 40, 41, 42. Coarse tuning of the device is achieved by rotating the magnets 10 to vary the field magnitude and therefore the resonance frequency, as described later.

The RF excitation pulses and signal acquisition are controlled with a conventional NMR console such as those known in the art, and a small module for tuning and matching the RF coil is also required.

Three configurations are possible in which the RF B₁ field is perpendicular to B₀ in a square four-magnet Halbach array with a simple RF coil 30 as a transmitter and receiver. These are shown in FIG. 3. Three configurations are also possible in which the RF B₁ field is perpendicular to B₀ in a square four-magnet Halbach array with a pair of RF coils 40, 41, 42 arranged as a Helmholtz pair. These are shown in FIG. 4.

The open-access device permits relaxation and diffusion measurements. However, the field strength may be too low, typically between 2 and 10 MHz, to permit meaningful NMR spectroscopy. This is not a serious disadvantage because other types of spectroscopy (infra-red, Raman, NIR etc) can provide simultaneous compositional information. Spatial imaging may be achieved in at least two ways. A three-dimensional, high resolution image is obtained at the resolution of the region of homogeneity by simply translating the sample inside the probe on an x-y-z stage 50, as shown in FIG. 5. Preferably, the stage is mechanically driven under computer control in accordance with an appropriate protocol to facilitate acquisition of localised NMR signals from different parts of the sample.

The resolution may be increased by moving the magnetised rods 10 inwards to reduce the size of the region of homogeneity (e.g. diminishing the size of the square or other polygon on whose corners the magnets are located) or by incorporating additional coil loops to spoil the homogeneity. Alternatively, an image can be obtained from within the region of homogeneity by imposing a linear field gradient and rotating the sample. Back-projection then allows two-dimensional imaging.

A sample under analysis is moved inside the magnet arrangement on the x-y-z stage 50. This permits crude imaging by allowing different parts of the sample to be examined.

FIG. 8 shows one version of the Halbach spectrometer 80 using one RF coil 30 in the configuration as also shown in FIG. 3a.

The open-access NMR apparatus as described herein advantageously is light-weight, enabling construction of mobile, hand-held systems with back-pack size consoles and power supplies that further widen the applications. The RF coil 30, 40, 41, 42 is preferably rigidly attached to the magnet rods so the probe is very robust. A mobile system such as this further widens the range of research applications. For example, utilizing the NMR apparatus, it is possible to examine, non-invasively, the ripeness and quality of fruit on the tree and of crops growing in the field.

Spectral Fusion with Other Sensors

As schematically illustrated in FIGS. 5 and 6, many types of sensors 55a-55d, 65a and 65b can be placed between the magnet rods 10, provided the sensors are made of non-magnetic materials. These can include NIR sensors for component analysis or some other appropriate sensing technology compatible with NMR. Combined NMR-impedance spectroscopy is another interesting possibility. A digital camera or CCD detector can be placed between the RF coils to take optical images of the sample.

Alternatively a 3-D laser scanner could be used to measure the 3D surface contour of the sample. Simple rheological measurements can be taken at the same time as the NMR acquisition, permitting the development of rheo-NMR where semi-solid samples are, for example, compressed, stretched or otherwise mechanically manipulated while simultaneously being examined with NMR.

In preferred embodiments, the magnet array includes at least one additional device 55, 65 for examining the sample which device does not interfere with acquisition of NMR information.

The at least one additional device 55, 65 may be an electromagnetic radiation emitting device. The electromagnetic radiation emitting device may comprise any one or more of an x-ray, ultraviolet, visible, near infra-red, infra-red and microwave emitting device.

The at least one additional device 55, 65 may emit particle beams, selected from the group consisting of electrons, protons, neutrons, and alpha particles.

The at least one additional device may comprise one or more mechanical probes that simultaneously manipulate the sample by stretching, compressing, shearing or otherwise altering the shape or flow characteristics of the sample.

The at least one additional device may be adapted to measure the dielectric properties of a sample in the sample volume 15. The device may comprise an impedance analyser and/or a dielectric spectrometer.

### Robotic Halbach NMR

Utilizing the NMR apparatus described herein in a “Robotic Halbach NMR” mode is achieved by exploiting the principle of motional relativity in the spin physics underpinning NMR and MRI. Conventional NMR and MRI is performed on stationary objects by rapidly switching magnetic field gradients and subjecting the sample to pulses of RF radiation [10]. But motional relativity states that NMR and MRI can be done in two other equivalent ways, namely by keeping all field gradients and RF fields constant and moving the sample in the fields, or by mechanically moving the fields over a stationary sample.

In the first way, samples moving at speeds up to 2 m/s (e.g. on industrial conveyors) through constant, spatially-characterised radiofrequency and magnetic fields have been analysed. Theory underlying this method has been defined in references [11] to [14].

The invention also provides for the second way, namely imaging by moving non-switched magnetic fields over a stationary sample. This has the potential for revolutionising the application of NMR and MRI throughout the scientific and industrial sectors by creating a wide range of novel, low-cost devices.

In this “motional-relativity” mode of performing NMR, the magnetic fields are created using either permanent magnets or electromagnets and these give rise to two quite distinct types of “robotic NMR”. In this disclosure, we focus on the permanent magnet case although the alternate of using electromagnets is clearly contemplated by this disclosure. Rather than using conventional pulsed NMR with the Halbach array, in this mode, we remove the need for RF excitation. Instead NMR is conducted simply by rotating the N magnets 10 (four magnets in the preferred illustrated examples) comprising the Halbach array using pneumatic (robotic) control. In the preferred arrangement, each of the permanent magnet rods 10 is independently rotatable about its longitudinal axis. In arrays where N>4, only some, or all, of the magnets may need to be rotated to achieve the corresponding effect. Thus, in a general aspect, the NMR apparatus preferably includes a robotic control system to synchronously rotate two or more of the magnets so as to vary the magnitude and/or direction of the B₀ field.

As shown in FIG. 2, counter-rotating adjacent magnet pairs through 90 degrees in the directions shown by curved arrows 23 changes the magnitude, but not direction of the field. This allows the field to be switched off (see FIG. 2c) in the few milliseconds required to rotate the magnets 10 through to their 90 degree position (magnet polarities all parallel). Thus, the apparatus preferably includes a robotic control system to synchronously counter-rotate adjacent pairs of the magnets to vary the magnitude but not direction of the B₀ field. The field can be reversed by continued rotation in the same directions as indicated by FIG. 2d where the magnets have rotated 180 degrees from their start position of FIG. 2a.

The effects of a conventional NMR “180 degree RF pulse” can be achieved without any RF excitation simply by co-rotating the magnets through 180 degrees in the same direction, as shown by the curved arrows 13 in FIG. 1. Rotation of the magnets 10 from the position in FIG. 1a to that of FIG. 1d results in inversion of the magnetic field. Continued rotation through 180 degrees returns the magnetic field to the original direction. Thus, the apparatus preferably includes a robotic control system adapted to synchronously co-rotate the magnets to vary the direction but not the magnitude of the B₀ field. Alternatively, for field inversion, the magnets could be counter-rotated through 180 degrees as shown by the curved arrows in FIG. 2 to achieve the effects of a conventional NMR 180 degree pulse without RF excitation.

A conventional NMR “90 degree RF pulse” is achieved by first nulling the field by counter-rotating the magnets to the position of FIG. 2c, then co-rotating two magnets on opposite corners through 180 degrees. For example, compare FIGS. 1c and 2c, in which co-rotation of magnets 10a and 10c transitions between the zero field of FIG. 2c and the 90 degree field of FIG. 1c. Thus, apparatus preferably also includes a control system for synchronously counter-rotating and/or co-rotating the magnets according to a programmed control sequence in order to achieve programmed variation in direction and/or magnitude of the B₀ field.

Nulling the field (FIG. 2c) is necessary to give non-adiabatic excitation, which prevents the magnetisation following the field reorientation. The net effect of the “pseudo-90 degree pulse” is, of course to give an NMR signal—a free induction decay (FID)—in any pick-up coil 30, 40, 41, 42 whose axis is perpendicular to the new direction of the external field. Dead-time problems are overcome by detecting a Hahn echo created by another field reversal. In this way, NMR is achieved without any RF excitation, merely by rotating the Halbach magnets 10. This revolutionary concept is referred to herein as “robotic NMR” because coordinated, programmed rotation of the magnets is performed by precise robotic control, e.g. preferably by a pneumatic drive system. The net result is to replace the RF excitation technology in NMR with pneumatic, robotic technology. This obviates the need for RF pulse modulators and expensive power amplifiers. Of course, the electronics for receiving, filtering and amplifying the RF current from the pick-up coil are still required, but this is all low-power and low-cost. Pneumatic robotic control systems are preferred so that electromagnetic field generating or disturbing devices such as motors and solenoids used for robotic control of the magnets can be remotely located.

The ability to vary the field strength (and therefore resonance frequency) in robotic NMR on the timescale of milliseconds has additional advantages over conventional, non-robotic NMR. Until now this was only possible in commercial field-cycling NMR spectrometers by switching off the current in an electromagnet. Unfortunately, this not only creates eddy currents, it also dumps all the magnetic field energy in the form of heat in the electromagnet coil, necessitating expensive primary and secondary cooling systems, pumps and heat exchangers in an effort to keep the magnet temperature constant. Not surprisingly the apparatus is very bulky and expensive and only used in specialist applications. In contrast, FIGS. 1 and 2 show that rotating the magnets only reduces the field in the “NMR active” central region of the field, not the whole field. There is therefore very little energy dumping when the resonance frequency is reduced, so it is easy to vary the field strength (resonance frequency) in robotic NMR. This opens up new possibilities for using the resonance frequency as a new dimension in NMR so that hitherto unexplored types of multidimensional, multifrequency NMR such as T₁(ω)-T₂ and T₁(ω)-D spectroscopy can be envisaged.

The preferred Halbach spectrometer described herein uses neodymium-ferrite magnets to create central fields of the order of 0.1 T so that the NMR signal can be detected using conventional pick-up RF coils. However new aspects of robotic NMR arise when combined with a high temperature DC-SQUID detector (superconducting quantum interference device). The SQUID detector detects changes in magnetic flux and so is used to detect NMR through changes in only the longitudinal magnetisation created through magnet rotation (see FIG. 2). The large flux created by rotating the magnets, of course, necessitates electronic gating of the SQUID receiver circuit during magnet rotation but an alternative uses two oppositely-wound pick-up coils inductively coupled to the SQUID, so that the effects of external noise and magnet rotation are cancelled out. This idea is currently used in SQUID gradiometers. The SQUID is extremely sensitive so that NMR transitions even at very low field strengths of microteslas can still be detected. This means that the Halbach magnets can be moved further apart, allowing for volume-selective studies on much larger samples. Another advantage of working at low field with a SQUID detector is that the effects of field inhomogeneity on line width are much less, so the lines are sharper and signal/noise correspondingly greater [15]. In fact, high resolution J-spectroscopy is possible, though, of course, chemical shift spectroscopy is not possible [16].

Motional relativity is also exploited for imaging applications with the Halbach array. In conventional MRI, a 3D image is usually built up by first selecting a slice perpendicular to one axis (e.g. z) then acquiring a raster of NMR signals acquired in ramped orthogonal pulsed gradients oriented in the plane to be imaged (the x-y plane). This requires expensive gradient amplifiers and control electronics. In robotic imaging there is no need for expensive gradient amplifiers and modulators because the effects of pulsed gradients in two directions (x-y) is equivalent to using a single fixed external linear field gradient (e.g. along x) and progressively reorienting the magnetisation relative to the x-gradient by adiabatically co-rotating the magnets as shown in FIG. 1. In the absence of RE excitation, slice selection in the z-direction is achieved by imposing a constant gradient along z (optionally by varying the thickness of the Halbach magnets) and using a high-Q planar looped RF pick-up coil that is only tuned to pick up signal from a narrow frequency range and therefore slice in the z-direction. A 3D image is then obtained using robotics to progressively move the sample through the RF coil in the z direction. In this way, full 3D imaging is achieved without any RF excitation and with only two fixed field gradients. In practice the inhomogeneity of the magnetic field map seen in FIG. 1 means that, unless the sample is small, the image would only be acquired from a small sub-volume within a larger sample. However, the location of the imaging sub-region within the sample is altered by translating and rotating the sample itself, on the x-y-z stage 50 which is preferably also achieved by means of pneumatic robotic control.

For 3D imaging, it is preferable for technical ease to utilize a mixture of robotic and RF technology by using soft, shaped RF excitation pulses to give slice selection in the z-direction and using robotics to spatially resolve in the x-y plane.

The open access nature of the Halbach array according to the present invention is another novel aspect to be exploited in the robotic mode, and three potential lines of development are noteworthy.

a) Development as a hetero-spectral multi-sensor. Because the Halbach magnet array is “open-access”, samples undergoing NMR can also be probed with other spectroscopies and/or scattering techniques including x-rays, neutrons and lasers, NIR and microwave reflectance. This opens the way to genuine NMR “sensor fusion” and hetero-spectral cross-correlation spectroscopy. This is beyond the capability of existing technology and is especially useful when the sample undergoes rapid and irreversible changes. Preliminary experiments with a fixed, non-robotic, Halbach array have already succeeded in combining NMR with impedance spectroscopy on a gel sample.

b) The open access arrangement also means that the samples can be mechanically manipulated while undergoing NMR so that new research areas such as soft-solid rheo-robotic Halbach NMR can be developed. To date this has only been achieved in conventional NMR with liquid samples by stirring [10].

c) Because the magnets are distanced from the sample and can be separately cooled, the Halbach system according to this invention is ideal for development of “extreme NMR” where the sample undergoing NMR/MRI is subjected to extremes of temperature and/or pressure.

Dimensional scaling of the robotic Halbach spectrometer is another important embodiment of the present invention. The four magnets of the preferred embodiment are located at the corners of a 75×75 mm square and use 18 mm thick neodymium-ferrite magnets. This gives a central active NIR region (sample volume) of about 1 cm³. However, there is nothing to prevent miniaturisation of the whole assembly. Much smaller permanent neodymium magnet rods, down to millimetre thicknesses, are commercially available, so the whole assembly could be scaled down to “match-box size” dimensions if required. Because there is no requirement for RF power, pulse programmers or pulsed gradients, it is possible to perform all the NMR using a palm-top PC controller. Moreover, a smaller magnet separation means that the field strength (resonance frequency) increases with miniaturisation, so that signal/noise ratio is improved allowing only microlitres of sample in a capillary tube to be examined. In addition reduced magnet size reduces moments of inertia and could make them easier to rotate. Accordingly, low-cost miniaturised, hand-held robotic micro-Halbach NMR systems are enabled by this disclosure.

The number of magnets in the Halbach array is another design variable. Replacing the four magnets in the prototype with N (>4) magnets at the corners of a regular N-sided polygon increases the field strength and signal/noise ratio. A ring of sixteen fixed neodymium-ferrite bar magnets has been developed for well-logging at a proton resonance frequency of 12.74 MHz (0.3 T) but this is a fixed “non-robotic” array [17]. Even higher field strengths can be achieved with a continuous Halbach cylinder of magnets although then the open-access advantages are lost and the individual magnets can no longer be rotated, so conventional RF excitation would be required, losing the novel “robotic” aspect of the NMR. Nevertheless it is interesting to note that the central field strength in two concentric Halbach cylinders can be varied by rotating one cylinder relative to the other and this may be advantageous for some specialist applications such as field-cycling NMR. Thus, is another aspect, there may be provided a second Halbach magnet array coaxial with and longitudinally overlapping a first Halbach magnet array. The second Halbach magnet array may be longitudinally coextensive with the first Halbach magnet array. The first and second Halbach arrays may be rotatable relative to one another, again using a robotic control system. The magnets of each of the first and second Halbach magnet arrays may be separately controllable for synchronised counter-rotation and/or co-rotation.

Using multiple Halbach arrays gives rise to yet another mode of performing NMR and MRI referred to herein as “translational Halbach NMR”. With reference to FIG. 10, a translational Halbach NMR apparatus 100 exploits another aspect of motional relativity, namely that the effect of rotating the field direction through an angle θ by rotating the magnets 10 in a single Halbach array can also be achieved by translating the sample 101 (e.g. on an x-y-z stage or a conveyor 150) along or parallel to the longitudinal axis 102 of two or more fixed Halbach magnet arrays 103, 104, 105 oriented at angles θ₁, θ₂, θ₃ about the longitudinal axis 102 with respect to each other.

The earlier discussion showed how Halbach arrays can give 90 degree and 180 degree pulses, so this implies that NMR can be done simply by translating a sample through a series of fixed Halbach magnet arrays 103, 104, 105, without the need for any RF excitation or pulsed field gradients, hence the name “translational Halbach NMR”.

The simplest situation is field reversal which involved counter-rotating the Halbach magnets through 180 degrees as shown in FIG. 2. But in translational Halbach NMR, the same effect can be achieved by moving the sample 101 at velocity ν along the axis 102 of a cylinder comprising two identical fixed Halbach segments 103, 104 oriented at 180 degrees to each other, i.e. one at θ=0 degrees and one at theta=180 degrees.

In like manner an RF-free “90 degree pulse” is achieved by sample translation through three segments of a cylinder. The first and third segments 103, 104 have Halbach arrays creating magnetic fields across the cylinder axis 102 but oriented at right angles to each other (e.g. θ=0 and θ=90) and they are separated by a short segment 106 of zero magnetic field (shielded with mu-metal). Other configurations may use further Halbach arrays 105 etc in successive segments.

A free induction decay is picked up by a solenoid coil 108 located inside the third segment 104. A spin echo with an echo time of TE is achieved by following this pseudo-90 degree segment with a two segment pseudo-180 degree region of total length, νTE.

Therefore, any simple pulse sequence is performed by translating a sample through a series of fixed Halbach arrays oriented along a long cylinder. Even a standard pulsed gradient spin-echo sequence used for diffusion measurements is performed using two fixed gradients created by Halbach magnets whose thickness increases in the direction of sample motion. This means that standard low-field NMR parameters such as longitudinal (T₁) and transverse (T₂) relaxation times, diffusion coefficients (D) and sample polarisation (M₀) are measured from samples moving on fast-moving conveyors through multiple Halbach segments without the need for RF excitation or any power supply, apart from the minimal power needed for the RF signal detection. Translational Halbach NMR is also ideally suited for development as a time-of-flight flow sensor for fluids in pipes and has the added advantage of giving additional information about fluid composition and foreign body content, which is especially useful for opaque emulsions and slurries.

Simple one-dimensional and two-dimensional imaging is achieved with translational Halbach NMR by acquiring spin-echoes in permanent field gradients oriented either along the cylinder axis or across it. Current research in on-line MRI by the inventor has already obtained image acquisition from samples translating at up to 1.3 m/s using conventional RF excitation and specially-designed fixed gradient coils. The same unique gradient coils are used with translational Halbach NMR and used for simple one- and two-dimensional imaging of fast-moving samples.

Other advantages of such on-line translational Halbach sensors include the following. They are low-cost and maintenance free, permanent fixtures requiring no power input, apart from the minor power needed for RF signal detection. They obviate the need for RF excitation or gradient pulsing. If used in conjunction with tuned SQUID detectors, they could be used around large cylinder diameters. High temperature, liquid nitrogen cooled, DC-SQUID detectors are commercially available so the sensor remains low-cost. The samples are translated at high velocity, and even accelerate under gravity.

On-line translational Halbach NMR sensors therefore have the potential of revolutionising, quality control and process monitoring in the industrial sector.

Few researchers in the biological, materials or process engineering sciences have easy access to NMR/MRI technology. Low-cost robotic Halbach NMR spectrometers according to the present invention change this situation and revolutionise research protocols in almost every scientific discipline by permitting NMR in the field, miniaturised NMR, field-cycling NMR and non-invasive real-time imaging. Research in plant development, animal embryology, food processing such as drying, freezing and cooking, water and oil distribution in soils and porous rock as well as medical research benefit enormously and are just a few of hundreds of potential research and quality-control applications. Furthermore, a Halbach imager takes high-resolution images from a small volume within an extended sample. It is therefore ideal for development as a low-cost scanner suitable for limb and even head examinations, thereby making the technology widely available in doctors' surgeries, and permits preliminary, non-invasive examination of conditions such as arthritis, sprains and fractures, tumours and internal injuries. The same is true in veterinary surgeries. In sports centres, rapid assessments could be made of injuries, the condition of joints and even of fat or muscle content utilizing an apparatus according to the present invention.

It should also be noted that the obesity epidemic sweeping the USA and Europe has placed great pressure on food manufacturers to label all food products with sugar, fat and protein content as well as calorific content. At present, this requires lengthy chemical analysis of each ingredient in the product, which is time-consuming and expensive. Robotic Halbach systems according to this invention may be used to advantage to determine the amounts and distribution of solid/liquid fat ratios, water and potentially, even biopolymer content throughout a prepared meal. Miniaturised, automated hand-held devices might even, eventually, find domestic application.

Translational Halbach sensing technology has the potential of revolutionising quality control and process monitoring of samples moving on conveyors or flowering through pipes. Examples include fruit and vegetable sorters, foreign body detection in foods; quality control in the pharmaceutical industry and flow and composition sensing in the oil and gas industry.

### Data Analysis

Heterospectral cross-correlation methods can be used to create multi-dimensional spectra based on combinations of the time-domain NMR signal with other spectroscopies. For example, multidimensional dielectric NMR relaxation spectra could be created by such data analysis methods on samples undergoing real-time changes such as heating, freezing, drying or other processing operations.

### Results

FIGS. 7a and 7b show the experimental CPMG echo decay envelope from an intact apple and raw egg (respectively) placed on top of the RF coil in the Halbach NMR spectrometer. FIG. 7c shows the corresponding result for a human finger held in the RF coil. This demonstrates that conventional NMR relaxometry can be readily achieved with the new spectrometer. Changes in these data as apples undergo internal quality changes (such as mealiness) or as eggs lose their freshness or if finger joints suffer from arthritis are potential applications for these few examples.

While the foregoing description enables those skilled in the art to make and use the present invention, those skilled in the art will understand that the present invention should not be understood as being restricted to the specifics of that description. Rather, the scope of the invention as disclosed herein is defined with reference to the claims appended to this description.

### EXAMPLES

Having generally described the invention above, the following examples are provided to extend the written description and to ensure that those skilled in the art are enabled to make and use the invention, including the best mode thereof. However, the invention should not be interpreted as being limited to the specifics of these examples. Rather, for an understanding of the scope of the invention contemplated herein, reference is made to the appended claims.

### Magnet and RF Coil Design

In one experiment according to this invention, as shown in FIG. 8, the Halbach array 80 was composed of a set of four strong composite permanent magnets 10. These were neodymium ferrite boron, type NdFeB N38H, 200 mm long by 18×18 mm square, fabricated by Magnet Sales & Service Ltd of Highworth, UK. The magnetic axis of each magnet 10 runs parallel to one of the 18 mm dimensions. An aluminium frame 81 comprising end plates 82a, 82b and longitudinal pillars 83 (only the front two pillars 83a and 83b are visible in FIG. 8) held the magnets 10 in a cuboid array having ends 74 mm square and height 200 mm, in such a way that the magnets 10 could be rotated about their long axes (i.e. the vertical axes as shown in the perspective view of FIG. 8), and then locked in position with their short sides at angles of 45° with respect to the frame 81 as shown in the figure. The frame may be formed from other suitable non-magnetic materials such as plastics.

This gave rise to the magnetic field pattern shown schematically in FIG. 1b with the B₀ field running diagonally across the frame 81 (i.e. in the horizontal plane as oriented in FIG. 8). The RF coil 30 was located in a horizontal plane halfway up the frame 81, with B₁ running vertically up the long central axis of the frame and therefore perpendicular to B₀.

Numerical modeling of the magnetic field from the four magnets in the above arrangement predicted a total field at the centre of 888+/−2 gauss in a 1 cm³ volume, corresponding to a 1 H resonance frequency of 3.78 MHz+/−8.5 kHz. This implies the field homogeneity is about +/−0.23% or 2300 ppm.

After experimenting with several RF coil designs, a good workable arrangement was found to be a simple short eight-turn solenoid coil, of diameter 4 cm and length 5 mm. The inductance of the coil 30 was measured to be 9.6 μH from ν=0 to 6 MHz. The coil was coupled through a conventional tuning and matching circuit, crossed diodes and a λ/4-equivalent network to a modified Resonance Instruments Maran spectrometer. A 1 H signal was obtained from doped water when the coil was tuned and matched at 3.87 MHz. The probe dead time was <˜30 μs and the best obtainable 90 degree RF pulse was 4.1 μs.

The open-access nature of the design means that it is undesirable to block access to the RF coil by any kind of shielding. However, shielding was found to be necessary to eliminate electromagnetic interference contributing to background noise. Thus, the entire magnet and RF coil system and the tuning/matching box was enclosed in a Faraday cage of thin copper mesh which was earthed to the receiver ground. When operating the equipment in different laboratories, it was seen that the interference was strongly environment-dependent. In a given situation, it may be appropriate not to use a Faraday cage, or to use a cage as large as necessary to enclose all equipment, or to use some other method of noise suppression.

Another potential problem is the temperature-dependence of the B₀ field. In some applications it may be desirable to control the temperature of the permanent magnets independently of the sample. This should be possible without compromising the open-access facility too much, by enclosing each of the magnets in a cooling jacket.

Experiments were performed using Hahn echo or CPMG pulse sequences on samples in conventional NMR tubes ranging over 5 to 18 mm diameter. To illustrate the open-access aspect of the instrument, whole fruit and eggs were also scammed by simply resting them on the RF coil, as well as a human finger (inserted through the coil) and a gel sample in a 2 cm diameter impedance cell. Considering the limitations of the design, especially low signal/noise ratio, the results were considered satisfactory and capable of yielding useful information, e.g. T₂s, M₀ ratios in solid/liquid mixtures etc as would be expected of any low-field NMR instrument.

To investigate the sensitivity of the RF coil, the relative integrated spin echo intensity was measured for a 2 Mm MnCl₂/H₂O doped water sample as a function of sample position inside the coil. FIG. 9 shows the variation along the coil axis. There was a variation of no more than ˜10% as a function of radial position in the plane of the coil. Most of the signal comes from a region within ˜2 cm above and below the coil. This permits a crude form of volume selectivity when large samples such as fruit are examined.

In conclusion, a rectangular Halbach magnet array as described herein is quite capable of being used for conventional low-field NMR. In conjunction with suitable shim and gradient coils the NMR capability of the system could be improved and extended. Above all, the open-access nature of the array allows a wide-variety of experimental scenarios in which NMR is coupled with other techniques, as outlined above. Many of these scenarios would be more difficult or impossible with a conventional magnet/probe design.

In another arrangement, the rods of the magnet array may be robotically controlled such that at least one of the magnets in the array is laterally displaceable, i.e. in a direction orthogonal to its longitudinal axis, to change one and/or both the B₀ field direction ands magnitude in the sample volume. Preferably all magnets in the array are laterally displaceable. In other words, by moving each magnet radially inwards or outwards in a synchronized manner relative to the centre of the polyhedron on which they are configured, it is possible to vary the magnitude of the field. This feature may be used to vary the resolution of the NMR signals being acquired. By varying one or more of the magnet positions independently, it is possible to vary the homogeneity of the field in the sample volume.

Varying the lateral position of one or more of the magnets can be effectively used to improve field homogeneity instead of conventional shimming magnets.

### REFERENCES

[1] K Halbach, “Permanent Magnets for Production and Use of High-Energy Particle Beams”, Proceedings of the Eighth International Workshop on Rare Earth Cobalt Permanent Magnets and their Applications, Dayton, Ohio (1985), 103.
[2] R M Pearson et al “Instrumentation for the Home Builder”, in The Encyclopaedia of Nuclear Magnetic Resonance vol. 4, 2569-2575, ed. D M Grant and R K Harris, John Wiley, 1996.
[3] G Moresi et al “Miniature Permanent Magnet for Table-top NMR”, Concepts in Magnetic Resonance Part B 19B(1) (2003), 35-43.
[4] H Raich et al “Design and Construction of a Dipolar Halbach Array with a Homogeneous Field from Identical Bar Magnets”: NMR Mandhalas, Concepts in Magnetic Resonance Part B 23B(1) (2004), 16-25.
[5] S Anferova et al “A Mobile NMR Device for Measurements of Porosity and Pore Size Distributions of Drilled Core Samples”, Concepts in Magnetic Resonance Part B 23B(1) (2004), 26-32.
[6] Y Maguire et al: “Towards a Table-top Quantum Computer, IBM Systems Journal 39(3&4) (2000), 823-839.
[7] I Noda et al: “Two-Dimensional Correlation Spectroscopy—Applications in Vibrational and Optical Spectroscopy”, John Wiley, 2004.
[8] G Eidmann et al: The NMR MOUSE, a Mobile Universal Surface Explorer, J. Magnetic Resonance Ser. A 122 (1996), 104-109.
[9] M C A Brown et al: Surface Normal Imaging with a Hand-Held NMR Device, J. Magnetic Resonance 169 (2004), 308-312.
[10] MRI in Food Science, B P Hills, John Wiley and Sons, New York, 1999.
[11] Patent application, publication WO99/38026
[12] Patent application, publication WO99/42852
[13] B P Hills: “NMR Imaging”, Chapter 9, page 154 in “Detecting Foreign Bodies in Food”, Ed M Edwards, Woodhead Publishing, Cambridge, 2004.
[14] B P Hills et al: “Towards on-line NMR sensors”, in “Magnetic Resonance in Food Science”, Royal Soc. of Chem, (in press)
[15] R McDermott et al, Science, 295 (2002) 2247
[16] R E de Souza et al: “NMR and MRI obtained with high temp dc SQUIDS”. J. Braz. Chem Soc, 10 (1999) 307.
[17] S Anferova et al: “Concepts in Magnetic Resonance Part B”, 23B(2004) 26.

1. A magnet array for use with NMR signal acquisition apparatus, comprising:
N rod-shaped magnets of length L and width D, where L>D, each magnet being located at a respective corner of a polyhedron having N sides and N corners where N is an integer greater than 2,
wherein the polyhedron lies in the (x-y) plane of a three dimensional Cartesian coordinate system with the long axes of the magnets extending generally along the z-direction such that the polarisation vectors of the N magnets lie substantially in the x-y plane and are arranged relative to one another so as to be capable of creating a substantially uniform magnetic field B₀ in a sample volume at the centre of the polyhedron,
wherein the width D of at least one magnet is less than the length of the corresponding side of the polyhedron so that there is a gap between at least two neighbouring magnet rods thereby providing lateral access in the x-y plane to the sample volume.

2. The magnet array of claim 1 in which the polyhedron is a regular polyhedron having N equal sides.

3. The magnet array of claim 1 in which the N magnets are exactly parallel.

4. The magnet array of claim 1 in which each magnet in the array is a permanent dipole magnet.

5. The magnet array of claim 1 in which N=4.

6. The magnet array of claim 1 further including means for transmitting radiofrequency (RF) radiation into the sample volume such that an RF magnetic field component B₁ lies in a direction perpendicular to B₀.

7. The magnet array of claim 5 in which the means for transmitting RF radiation comprises a single coil or a pair of coils also for receiving NMR signals.

8. The magnet array of claim 6 in which the coil or coils are oriented to produce said RF B₁ field perpendicular to said B₀ magnetic field.

9. The magnet array of claim 1 wherein each of said permanent magnet rods is independently rotatable around its longitudinal axis.

10. The magnet array of claim 1 in which the magnets are formed of neodymium-ferrite.

11. The magnet array of claim 1 in which the magnets are held in place at longitudinal ends thereof with a non-magnetic material.

12. The magnet array of claim 1 further including a stage for supporting a sample within the sample volume that is movable within or through the sample volume.

13. The magnet array of claim 11 in which the sample stage is movable in the x, y and z directions.

14. The magnet array of claim 1 in which each magnet is rotatable about its longitudinal (z) axis under the control of a robotic system to change one and/or both the B₀ field direction and magnitude in the sample volume.

15. The magnet array of claim 13 in which the control system is adapted to synchronously counter-rotate adjacent pairs of the magnets to vary the magnitude but not direction of the B₀ field.

16. The magnet array of claim 13 in which the control system is adapted to synchronously co-rotate the magnets to vary the direction but not the magnitude of the B₀ field.

17. The magnet array of claim 13 in which the control system is adapted to rotate the magnets in a coordinated mode to vary the resonance frequency, defined by ω₀=γB₀ of the system to enable coarse tuning of NMR acquisition and field cycling NMR.

18. A magnet array for use with NMR signal acquisition apparatus, comprising:
N rod-shaped magnets of length L and width D, where L>D, each magnet being located at a respective corner of a polyhedron having N sides and N corners where N is an integer greater than 2,
wherein the polyhedron lies in the (x-y) plane of a three dimensional Cartesian coordinate system with the long axes of the magnets extending generally along the z-direction such that the polarisation vectors of the N magnets lie substantially in the x-y plane and are arranged relative to one another so as to be capable of creating a substantially uniform magnetic field B₀ in a sample volume at the centre of the polyhedron,
wherein some or each of the magnets are rotatable about their respective longitudinal axes under the control of a robotic system to change one and/or both the B₀ field direction and magnitude in the sample volume.

19. The magnet array of claim 18 in which the control system is adapted to synchronously rotate selected magnets so as to vary the magnitude and/or direction of the B₀ field.

20. The magnet array of claim 18 in which the control system is adapted to synchronously counter-rotate adjacent pairs of the magnets to vary the magnitude but not direction of the B₀ field.

21. The magnet array of claim 18 in which the control system is adapted to synchronously co-rotate the magnets to vary the direction but not the magnitude of the B₀ field.

22. The magnet array of claim 18 in which the control system is adapted to synchronously counter-rotate and/or co-rotate some or all of the magnets according to a programmed control sequence in order to achieve programmed variation in direction and/or magnitude of the B₀ field.

23. The magnet array of claim 18 in which the control system is adapted to rotate the magnets in a coordinated mode to vary the resonance frequency, defined by ω₀=γB₀ of the system to enable coarse tuning of NMR acquisition and field cycling NMR.

24. A magnet array for use with NMR signal acquisition apparatus, comprising:
N rod-shaped magnets of length L and width D, where L>D, each magnet being located at a respective corner of a polyhedron having N sides and N corners where N is an integer greater than 2,
wherein the polyhedron lies in the (x-y) plane of a three dimensional Cartesian coordinate system with the long axes of the magnets extending generally along the z-direction such that the polarisation vectors of the N magnets lie substantially in the x-y plane and are arranged relative to one another so as to be capable of creating a substantially uniform magnetic field B₀ in a sample volume at the centre of the polyhedron,
wherein at least one magnet is displaceable in a direction orthogonal to its longitudinal axis under the control of a robotic system to change one and/or both the B₀ field direction and magnitude in the sample volume.

25. The magnet array of claim 24 in which the control system is adapted to vary the radial position of each magnet relative to the centre of the polyhedron to vary the homogeneity of the field in the sample volume.

26. The magnet array of claim 1, claim 18 or claim 24 further including a second magnet array coaxial with the first magnet array.

27. The magnet array of claim 26 in which the second magnet array is longitudinally adjacent to the first magnet array.

28. The magnet array of claim 26 in which the second magnet array is longitudinally overlapping the first magnet array.

29. The magnet array of claim 26 in which the second magnet array is longitudinally adjacent to the first magnet array.

30. The magnet array of claim 26 further including a transport mechanism to pass samples sequentially through the first and second magnet arrays.

31. The magnet array of claim 26 in which the first and second magnet arrays are rotatable relative to one another about the longitudinal axis.

32. The magnet array of claim 1, claim 18 or claim 24 further including a sample stage adapted to support a sample within the sample volume, the sample stage being moveable under automatic control along at least one of the x, y and z-axes.

33. The magnet array of claim 31 in which the sample stage is moveable under automatic control along all three of the x, y and z-axes.

34. The magnet array of claim 1, claim 18 or claim 24 further including an analysis module for directing electromagnetic radiation at, and/or receiving electromagnetic radiation from, a sample contained within the sample volume along a direction of access orthogonal or transverse to the longitudinal axes of the magnets.

35. The magnet array of claim 1, claim 18 or claim 24 further including an analysis module for directing emitted particle beams at a sample contained within the sample volume along a direction of access orthogonal or transverse to the longitudinal axes of the magnets, the particle beams selected from the group consisting of electrons, protons, neutrons, and alpha particles.

36. The magnet array of claim 1, claim 18 or claim 24 further including at least one mechanical probe operable external of the magnet array and extending into the sample volume for manipulating a sample therein.

37. The magnet array of claim 36 in which the probe is adapted to perform one or more of stretching, compressing, shearing or otherwise altering the shape or flow characteristics of the sample.

38. The magnet array of claim 34 in which the analysis module comprises an impedance analyser and/or a dielectric spectrometer.
